(19) United States
(12) Patent Application Publication
(10) Pub. No.: US 2010/0278585 A1
(43) Pub. Date: Nov. 4, 2010

(54) Connector structure of a music instrument stand

(76) Inventor: Chang Ming Yi, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,659

(22) Filed: Jan. 28, 2008

(51) Int. Cl. F16D 1/12

(52) U.S. Cl. 403/103

(57) ABSTRACT

A connector structure of a music instrument stand includes a first connector and a second connector. Each of the connectors has an annular gear part that matches with each other. A first through hole and a second through hole are formed at the center of the annular gear parts of the two connectors, respectively. A screw is fastened from the first through hole to the second through hole and fixed so that the two connectors can pivotally rotate. Each of the connectors has a groove for the disposition of a bar. A corresponding cover covers the bar and is fixed by a screw and a nut.

### BACKGROUND OF THE INVENTION

1. Field of Invention

The invention relates to a music instrument stand and, in particular, to a connector structure of a music instrument stand that can be quickly assembled and disassembled.

2. Related Art

FIG. 5 shows a conventional music instrument fixed on an instrument stand 6. Connectors 61, 62 of different specifications and structures are used to connect various bars into a three-dimensional instrument stand 6.

However, the connectors have different specifications in order to support bars in different orientations. Therefore, all the connectors are needed in order to assemble the entire music instrument stand.

After the assembly is done, it is inconvenient to adjust individual angles of the main music instrument. It is necessary to take off all the connectors in order to disassemble the stand. Therefore, how to quickly and easily assemble/disassemble the instrument stand without worrying about having all the connectors with different specifications is the goal of the invention.

### SUMMARY OF THE INVENTION

An objective of the invention is to solve the above-mentioned problems by providing a connector structure of a music instrument stand. The invention only requires connectors of a single specification. The disclosed music instrument stand can be quickly assembled/disassembled.

To achieve the above objective, the invention includes a first connector, a second connector, and two covers.

The first connector has a first surface and a second surface. The first surface has a first annular gear part and a first groove. A first through hole from the first surface to the second surface is formed at the center of the first annular gear part. The first groove has an opening going axially through the two ends. The second surface has at least one first lock hole going from the first surface to the second surface.

The second connector has a third surface and a fourth surface. The third surface has a second annular gear part corresponding to the first annular gear part and a second groove. A second through hole is formed at the center of the second annular gear part corresponding to the first through hole. A pushing part is provided on one end along the axial direction of the second groove. An opening is formed opposite to the pushing part. The fourth surface has at least a second lock hole going from the third surface to the fourth surface.

The two covers have a first face and a second face. The first face has a third groove with an opening axially going through the two ends. The first face has at least a third lock hole going from the first face to the second face. The third lock hole corresponds to the first lock hole and the second lock hole.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the invention;

FIG. 2 is a schematic view of the three-dimensional assembly of the invention;

FIG. 3 is a schematic view showing the pivotal part of the disclosed connector;

FIG. 4 is a schematic view showing the disclosed connector when it is folded away; and

FIG. 5 is a schematic view of a conventional music instrument stand.

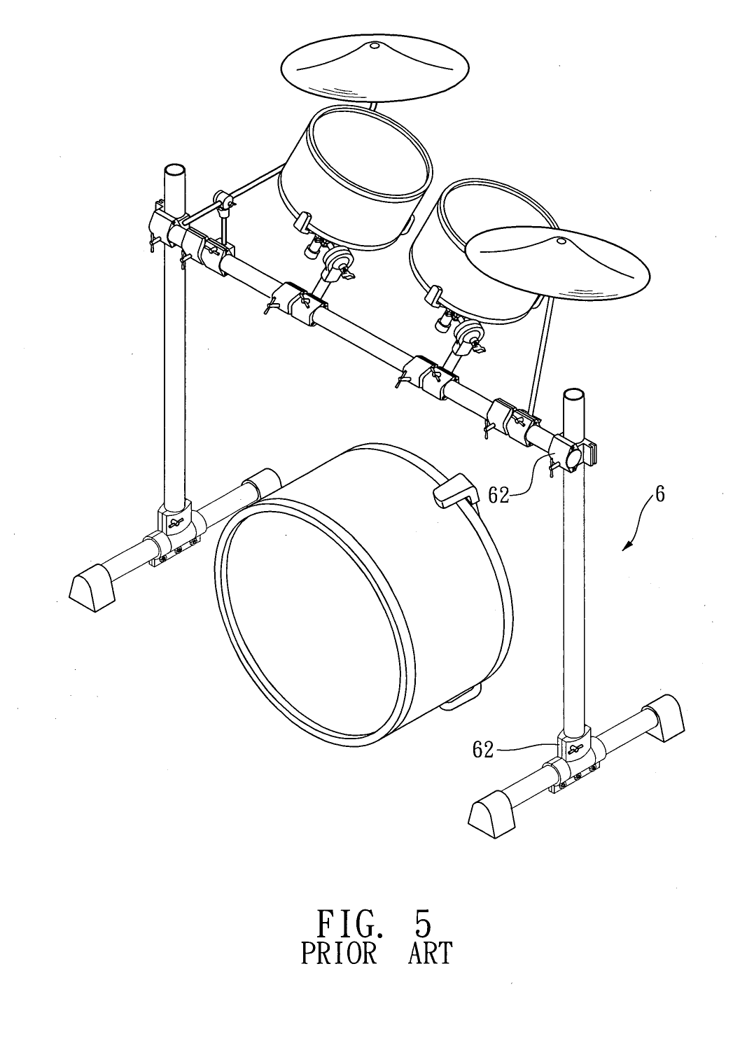

### DETAILED DESCRIPTION OF THE INVENTION

The present invention will be apparent from the following detailed description, which proceeds with reference to the accompanying drawings, wherein the same references relate to the same elements.

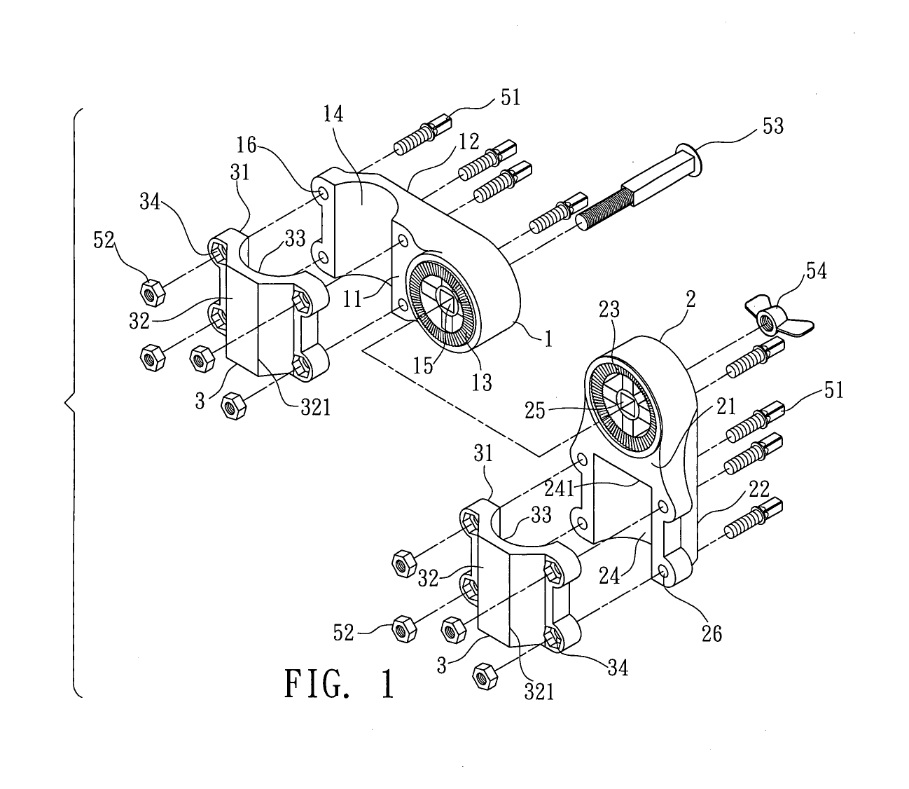

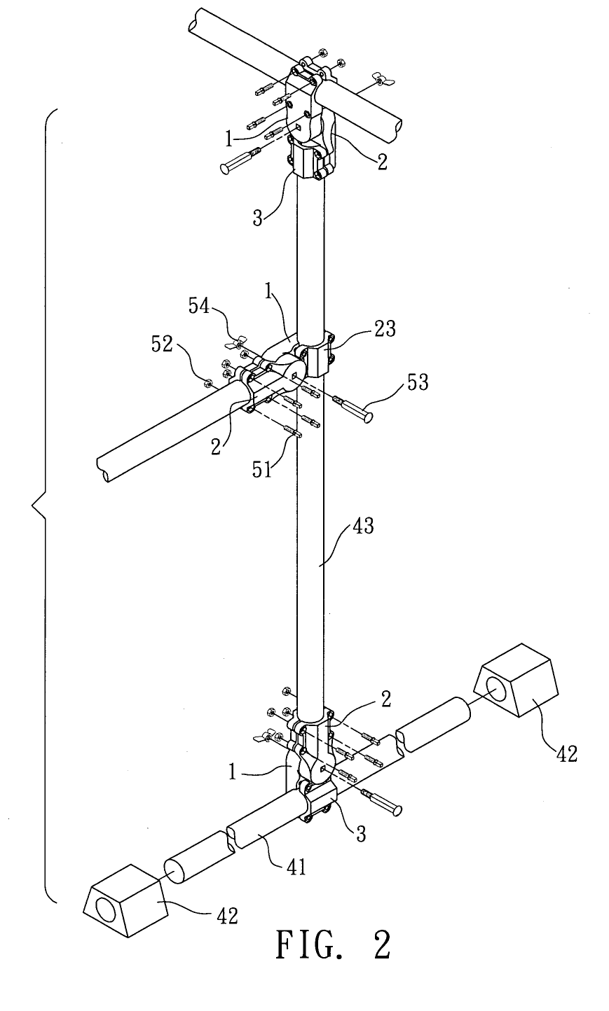

Please refer to FIGS. 1 and 2. They show the structure of the disclosed connector according to a preferred embodiment. This embodiment is only an example of the invention. The scope of the invention is defined by the claims hereinafter.

The disclosed connector structure of a music instrument stand includes a first connector 1, a second connector 2, and two covers 3.

The first connector 1 has a first surface 11 and a second surface 12. The first surface 11 has a first annular gear part 13 and a first groove 14. In this embodiment, the first annular gear part 13 is protruding. A first through hole 15 goes through the center of the first annular gear part 13. In this embodiment, the first through hole is a square hole going from the first surface 11 to the second surface 12. The first groove 14 has an opening going axially through the two ends. The second surface 12 has at least one first lock hole 16 going from the first surface 11 to the second surface 12.

The second connector 2 has a third surface 21 and a fourth surface 22. The third surface 21 has a second annular gear part 23 corresponding to the first annular gear part 13 and a second groove 24. In this embodiment, the second annular gear part 23 is receding. A second through hole 25 is formed at the center of the second annular gear part 23 corresponding to the first through hole 15. In this embodiment, the second through hole 25 is the same square hole as the first through hole 15. A pushing part 241 is provided on one end along the axial direction of the second groove 24. An opening is formed opposite to the pushing part 241. The fourth surface 22 has at least a second lock hole 26 going from the third surface 21 to the fourth surface 22.

The two covers 3 have a first face 31 and a second face 32. The first face 31 has a third groove 33 with an opening axially going through the two ends. The first face 31 has at least a third lock hole 34 going from the first face 31 to the second face 32. The third lock hole 34 corresponds to the first lock hole 16 and the second lock hole 26.

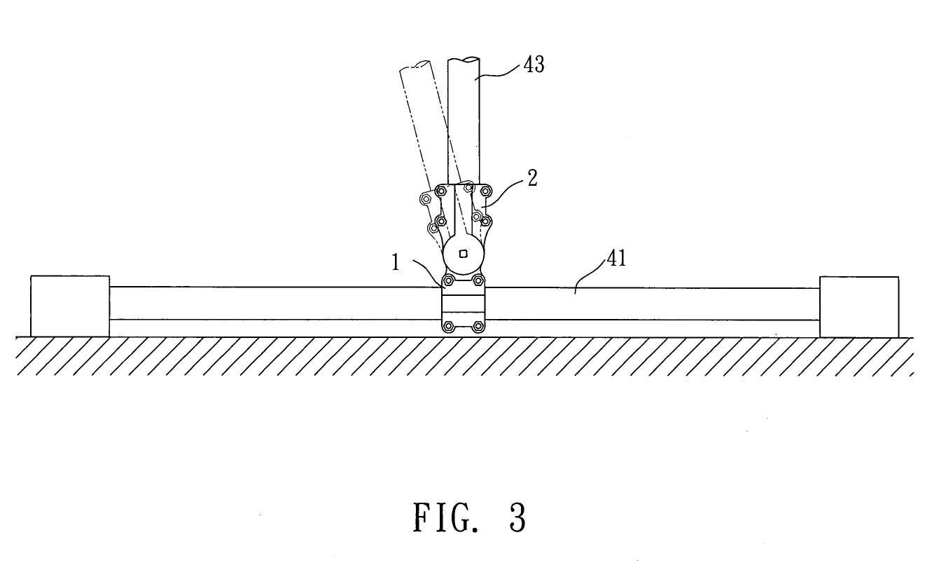

To assemble the disclosed music instrument stand, one first mount a pod base 42 on both ends of a bar 41. The bar 41 is disposed in the first groove 14 of the first connector 1. One cover 3 covers the bar 41 by matching the third groove 33 with the first groove 14. Afterwards, a screw 51 is fastened from the first lock hole 16 to the third lock hole 34 and fixed by a nut 52. Afterwards, the second annular gear part 23 of the second connector 2 is connected with the first annular gear part 13 of the first connector 1. A fastening element 53 is inserted from the first through hole 53 to the second through hole 25 and fixed by a butterfly nut 54. When the butterfly but 54 is loosened, the first connector 1 and the second connector 2 can rotate, as shown in FIG. 3. Their angles can be adjusted. Afterwards, another bar 43 is disposed in the second groove 24 of the second connector 2 in the same way as the first connector 1. The third groove 33 of the other cover 3 is matched with the second groove 24. A screw 51 is fastened from the second lock hole 26 to the third lock hole 34 and fixed by a nut 52. Since the second groove 24 has the pushing part 241 to push one end of the bar 43 so that the bar 43 does not make the bar 51 slide because the screw 51 is loose. The cover has two angles 321 to strengthen the outer surface strength thereof.

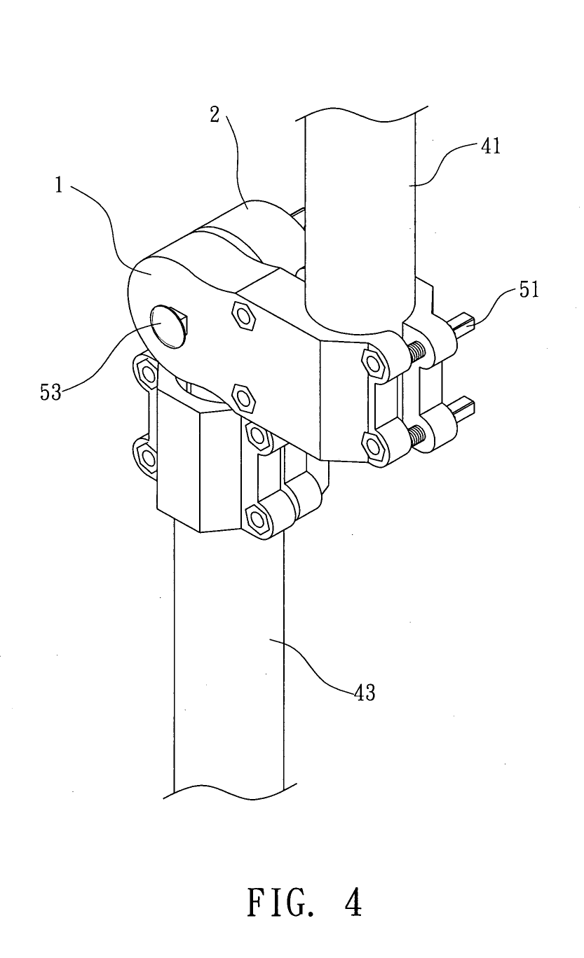

Please refer to FIG. 4. To fold the instrument stand away, one only needs to loosen the butterfly nuts 54 locked on the first through hole 15 and the second through hole 25. The first connector 1 and the second connector 2 can thus be rotated so that the bars 41, 43 become parallel to each other. This then folds the instrument stand away.

In summary, using connectors of the same specification in a music instrument stand enables one to quickly and conveniently assemble it. At the same time, the angles of the instrument can be adjusted. To put it away, the user only needs to loosen and rotate the connectors so that the bars are parallel to each other. Thus, the invention can be easily assembled/disassembled.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A connector structure of a music instrument stand, comprising:
a first connector, which has a first surface and a second surface, wherein the first surface has a first annular gear part and a first groove, a first through hole from the first surface to the second surface is formed at the center of the first annular gear part, the first groove has an opening going axially through the two ends, and the second surface has at least one first lock hole going from the first surface to the second surface;
a second connector, which has a third surface and a fourth surface, wherein the third surface has a second annular gear part corresponding to the first annular gear part and a second groove, a second through hole is formed at the center of the second annular gear part corresponding to the first through hole, a pushing part is provided on one end along the axial direction of the second groove, an opening is formed opposite to the pushing part, and the fourth surface has at least a second lock hole going from the third surface to the fourth surface; and
two covers, which have a first face and a second face, wherein the first face has a third groove with an opening axially going through the two ends, the first face has at least a third lock hole going from the first face to the second face, and the third lock hole corresponds to the first lock hole and the second lock hole.

2. The connector structure of a music instrument stand as in claim 1, wherein the first annular gear part of the first connector and the second gear part of the second connector correspond to each other, and a screw is fastened from the first through hole to the second through hole and fixed for the first connector and the second connector to rotate.

3. The connector structure of a music instrument stand as in claim 1, wherein the first through hole and the second through hole are square holes.

4. The connector structure of a music instrument stand as in claim 1, wherein the first annular gear part is protruding.

5. The connector structure of a music instrument stand as in claim 1, wherein the second annular gear part is receding.

6. The connector structure of a music instrument stand as in claim 1, wherein the third groove of the second face of the cover corresponds to the first groove of the first connector, and a screw is fastened from the third lock hole to the first lock hole and fixed by a nut.

7. The connector structure of a music instrument stand as in claim 1, wherein the third groove of the second face of the cover corresponds to the second groove of the second connector, and a screw is fastened from the third lock hole to the second lock hole and fixed by a nut.

8. The connector structure of a music instrument stand as in claim 1, wherein the second face of the second cover has two angles to strengthen the outer surface thereof.
